(19) United States
(12) Patent Application Publication
(10) Pub. No.: US 2008/0117734 A1
(43) Pub. Date: May 22, 2008

(54) TRACK-JUMPING METHOD FOR OPTICAL DISK DRIVE

(75) Inventor: I-Chun Tseng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/562,962

(22) Filed: Nov. 22, 2006

(51) Int. Cl. G11B 7/00

(52) U.S. Cl. 369/44.28

(57) ABSTRACT

An optical disk drive is used for recording data to and/or reproducing data from an optical disk. The optical disk drive includes a storing module, a controlling module, an actuator, and a pickup head. The actuator is connected to the controlling module. The storing module is used for storing at least one measured tracking error signal. The controlling module is used for generating the adjusted track-jumping control signal based on the track-jump command and a measured tracking error signal chosen from the storing module. The actuator is used for generating a driving force based on the adjusted track-jumping control signal to move the pickup head to a targeted position by the driving force.

### BACKGROUND OF THE INVENTION

1. Field of the Invention

The present invention generally relates to track-jumping methods for optical disk drives, and more particularly to an optical disk drive and a track-jumping method used by the optical disk drive to record data to and/or reproduce data from an optical disk.

2. Description of Related Art

Generally, an optical disk drive uses an optical disk as a recording medium. The optical disk includes a plurality of concentric or spiral tracks formed on a recording surface. The optical disk drive records data on the tracks by projecting a light beam on the tracks, and reproduces signals recorded on the tracks by detecting a reflected light beam from the tracks.

Referring to FIG. 1, an optical disk drive 400 that records data to and/or reproduces data from an optical disk 450 is shown. The optical disk 400 includes an actuator 430 and a pickup head (PUH) 440. The actuator 430 is used for moving the pickup head 440. The actuator 430 includes a rotatable worm gear 432. The PUH 440 is meshed with the worm gear 432. When the worm gear 432 rotates, the PUH 440 moves along a rotating axis of the worm gear 432.

The optical disk drive 400 needs to perform a track-jumping operation, when reproducing data on a targeted track 454 of the optical disk 450. Initially, the PUH 440 is at a current position 433 of the worm gear 432 corresponding to a current track 453 of the optical disk 450. The actuator 430 generates a driving force to drive the worm gear 432 to rotate. Finally, the PUH is moved from the current position 433 to the targeted position 434 of the worm gear 432.

The PUH 440 projects light beams on a targeted track 454 corresponding to the targeted position 454. Referring to FIGS. 2A, 2B, and 2C, the PUH 440 projects a main light beam 442, and two subsidiary light beams 444 and 446 on the targeted track 454. The subsidiary light beams 444 and 446 are on two sides of the main light beam 442, and are at equal distances from the main light beam 442 in a radial direction of the targeted track 454. Overlapping areas between the light beams and the targeted track 454 are indicated with shadows.

According to FIG. 2A, the main light beam 442 is fully projected onto the targeted track 454, and each of the subsidiary light beam 444 and 446 is only partially projected onto the targeted track 454. The overlapping area of the subsidiary light beam 444 and the targeted track 454 is equal to that of the subsidiary light beam 446 and the targeted track 454. Herein, the PUH 440 accurately aims at the targeted track 454.

According to FIG. 2B, the subsidiary light beam 444 is fully projected on the targeted track 454, the main light beam 442 is partially projected on the targeted track 454, and the subsidiary light beam 446 is not projected on the targeted track 454. In addition, there are other cases. One case is where the main light beam 442 is not projected on the targeted track 454. Another case is where the subsidiary light beam 444 and the subsidiary light beam 446 both are projected on the targeted track 454, and the overlapping area of the subsidiary light beam 444 and the targeted track 454 is greater than that of the subsidiary light beam 446 and the targeted track 454. Herein, the PUH 440 still does not reach the targeted position 434, and does not accurately project at the targeted track 454.

According to FIG. 2C, the subsidiary light beam 446 is fully projected on the targeted track 454, the main light beam 442 is partially projected on the targeted track 454, and the subsidiary light beam 444 is not projected on the targeted track 454. Furthermore, there are other cases. One case is where the main light beam 442 is not projected on the targeted track 454. Another case is where the subsidiary light beam 444 and the subsidiary light beam 446 both are projected on the targeted track 454, and the overlapping area of the subsidiary light beam 446 and the targeted track 454 is greater than that of the subsidiary light beam 444 and the targeted track 454. Herein, the PUH 440 is beyond the targeted position 434, and does not accurately project at the targeted track 454.

FIG. 2A shows an ideal case of the track-jumping operation. However, in practice, cases of FIGS. 2B and 2C are more common. Therefore, the actuator 430 further needs to adjust the PUH 440.

Referring also to FIG. 3, the conventional optical disk drive 400 also includes a command-generating apparatus 410, a controller 420, and a amplifier 460. The command-generating apparatus 410 generates a track-jump command, and sends the track-jump command to the controller 420. The track-jump command contains information indicating the targeted track 454. The controller 420 generates an initial control signal based on the track-jump command, and sends the initial control signal to the actuator 430. The actuator 430 generates the driving force to move the PUH 440 to the targeted position 434 based on the initial control signal.

The PUH 440 projects light beams on the targeted track 454 and receives reflected light beams from the targeted track 454. Next, the PUH 440 measures an offset of the light beams to the targeted track 454, and generates a tracking error signal (TES) based on the offset. The amplifier 460 amplifies the TES, and sends the amplified TES to the controller 420. The controller 420 generates an inching-adjusting signal, and sends the inching-adjusting signal to the actuator 430. The actuator 430 generates an inching-adjusting force to move the PUH 440 to the targeted track.

However, the track-jumping operation is always repeated many times before the light beams accurately projects on the targeted track. Thus, the track-jumping operation is time consuming.

Therefore, an optical disk drive and a track-jumping method for an optical disk drive are needed in the industry to address the aforementioned deficiencies and inadequacies.

### SUMMARY OF THE INVENTION

An optical disk drive is used for recording data to and/or reproducing data from an optical disk. The optical disk drive includes a storing module, a controlling module, an actuator, and a pickup head. The actuator is connected to the controlling module. The storing module is used for storing at least one measured tracking error signal. The controlling module is used for generating the adjusted track-jumping control signal based on the track-jump command and a measured tracking error signal chosen from the storing module. The actuator is used for generating a driving force based on the adjusted track-jumping control signal to move the pickup head to a targeted position by the driving force.

Other systems, methods, features, and advantages of the present parameters calibrating system and method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present optical disk drive and the present track-jumping method can be better understood with reference to the following drawings. The components in the drawings are not necessarily to scale, emphasis instead being position d upon clearly illustrating the principles of the present device. Moreover, in the drawings, like reference numerals designate corresponding parts throughout the several views.

FIG. 1 is a schematic diagram showing a moving mechanics of a pickup head (PUH) of an optical disk;

FIGS. 2A, 2B, and 2C are schematic diagrams showing different positioning relationships of light beams projected from the PUH of FIG. 1 and a targeted track of an optical disk;

FIG. 3 is a block diagram showing the optical disk drive comprising the PUH of FIG. 1;

FIG. 4 is a schematic diagram showing an optical disk with five imaginary rings in accordance with an exemplary embodiment;

FIG. 5 is a block diagram illustrating an optical disk drive with the optical disk of FIG. 4 in accordance with a first exemplary embodiment, the optical disk drive including a track-jumping apparatus;

FIG. 6 is a block diagram illustrating an optical disk drive with the optical disk of FIG. 1 connecting to a personal computer (PC) in accordance with a second exemplary embodiment, the optical disk drive including the track-jumping apparatus of FIG. 5;

FIG. 7 is a flowchart illustrating a track-jumping method in accordance with an exemplary embodiment, the track-jumping method including three steps;

FIG. 8 is a flowchart of the first step of FIG. 7 in detail;

FIG. 9 is a flowchart of the second step of FIG. 7 in detail; and

FIG. 10 is a flowchart of the third step of FIG. 7 in detail.

### DETAILED DESCRIPTION OF THE INVENTION

Reference will now be made to the drawings to describe preferred embodiments of a present optical disk drive and a preferred embodiment of the present track-jumping method.

In the embodiments, an optical disk is mapped with a plurality of imaginary rings. A track-jumping apparatus of the optical disk drive obtains a measured tracking error signal (TES) for each imaginary ring, and stores the measured TES. When performing a track jump, the track-jumping apparatus receives a track-jump command and reads the measured TES correspondingly, and then adjusts the track-jump command with the measured TES to generate an adjusted track-jumping control signal. The optical disk drive moves a pickup head to a targeted position based on the adjusted track-jumping control signal.

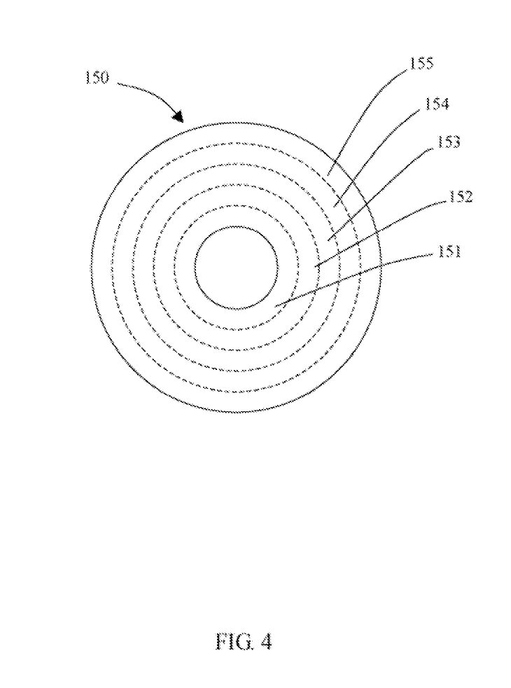

Referring to FIG. 4, an optical disk 150 is mapped with five imaginary rings 151, 152, 153, 154, and 155. The rings are concentric rings. Each ring has a same radial width and includes a plurality of data tracks.

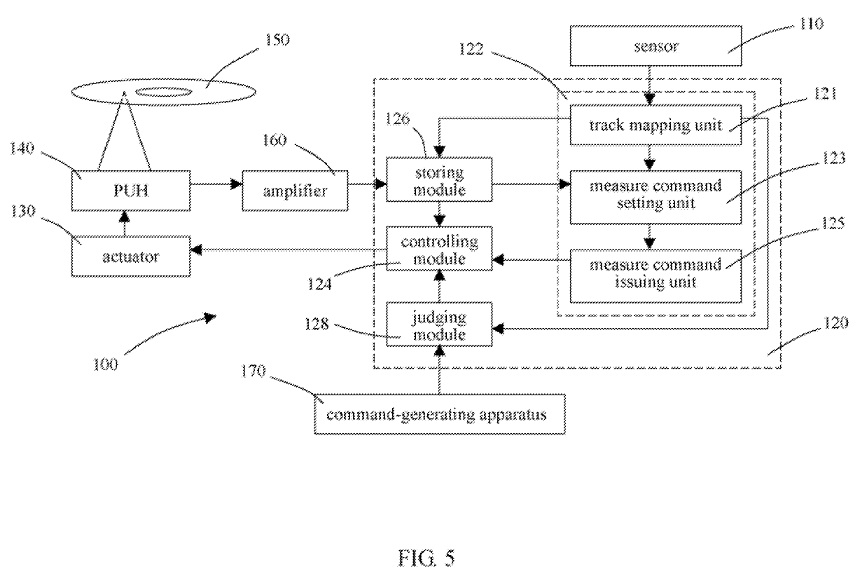

Referring to FIG. 5, an optical disk drive 100 in accordance with a first exemplary embodiment is used for recording data to and/or reproducing data from an optical disk 150. The optical disk drive 100 includes a sensor 110, a track-jumping apparatus 120, an actuator 130, a pickup head (PUH) 140, an amplifier 160, and a command-generating apparatus 170. The track-jumping apparatus 120 is connected to the sensor 110 and the command-generating apparatus 170. The command-generating apparatus 170, the track-jumping apparatus 120, and the actuator 130 are connected in series.

The sensor 110 is used for detecting when the optical disk 150 is loaded into the optical disk drive 100, then signaling the track-jumping apparatus 120 to generate and send a driving signal to the actuator 130. The actuator 130 is used for creating a driving force based on the driving signal to move the PUH 140 to a targeted position corresponding to a targeted track of the optical disk 150. The PUH 140 is used for projecting light beams onto the targeted track, receiving reflected light beams from the targeted track, and obtaining a measured TES by analyzing the reflected light beam. The amplifier 160 is used for amplifying the measured TES. The command-generating apparatus 170 is used for transmitting the track-jump commands to the track-jumping apparatus 120.

The track-jumping apparatus 120 includes a measuring module 122, a controlling module 124, a storing module 126, and a judging module 128. The measuring module 122 is connected to the sensor 110, the controlling module 124, and the storing module 126. The controlling module 124 is connected to the measuring module 122, the storing module 126, and the judging module 128. The storing module 126 is connected to the measuring module 122, the controlling module 124, and the amplifier 160. The judging module 128 is connected to the measuring module 122, the controlling module 124, and the command-generating apparatus 170.

The measuring module 122 is used for receiving the disk detected signal, issuing get TES commands to the controlling module 124, and generating and sending mapping divisions data to the judging module 128. The storing module 126 is used for storing the measured TES. The judging module 128 is used for receiving the track-jump command and the mapping divisions data. The track-jump command includes a targeted track, and the mapping divisions data indicates the five imaginary rings of the optical disk 150. The judging module 128 is also used for computing a significant ring of the five imaginary rings containing the targeted track of the track-jump command. The imaginary ring that contains the targeted track is referenced as the significant ring. Furthermore, the judging module 128 is also used for generating and sending a seek signal to the controlling module 124, and for issuing the track-jump command to the controlling module 124.

The controlling module 124 is used for generating and sending the driving signal based on the get TES command, and sending the driving signal to the actuator 130. The controlling module 124 is also used for reading the measured TES from the storing module 126 corresponding to the significant ring, and generating the adjusted track-jumping control signal based on the measured TES and the track-jump command, and for sending the adjusted track-jumping control signal to the actuator 130.

The measuring module 122 includes a track mapping unit 121, a measure command setting unit 123, and a measure command issuing unit 125. The track mapping unit 121 is connected to the sensor 110, the measure command setting unit 123, the storing module 126, and the judging module 128. The measure command setting unit 123 is connected to the track mapping unit 121, the measure command issuing unit 125, and the storing module 126. The measure command issuing unit 125 is connected between the measure command setting unit 123 and the controlling module 124.

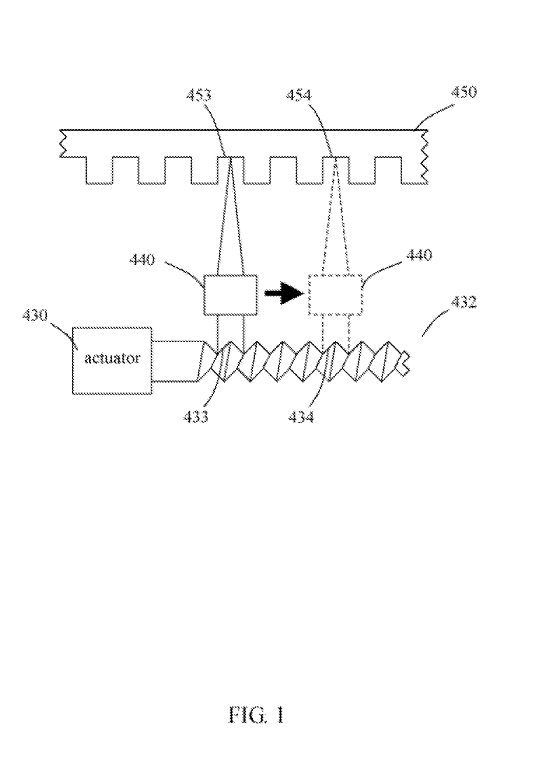

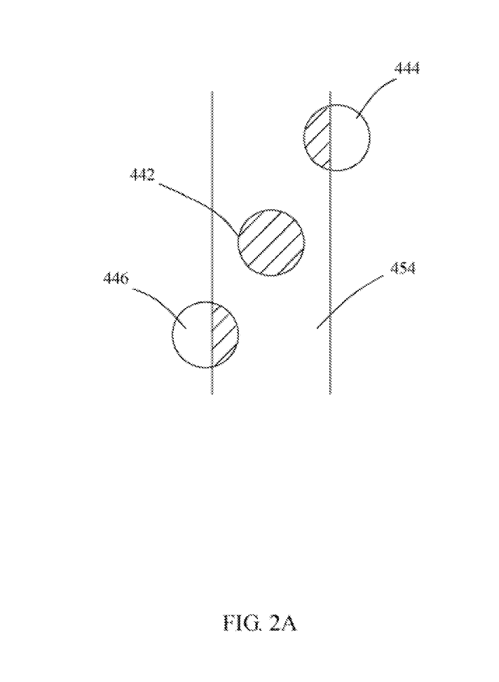

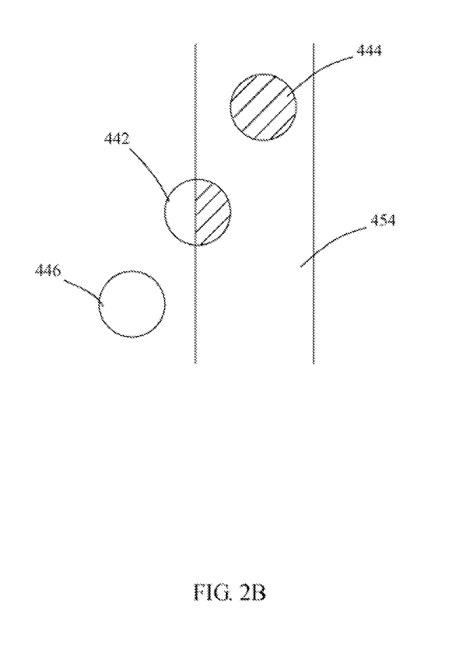

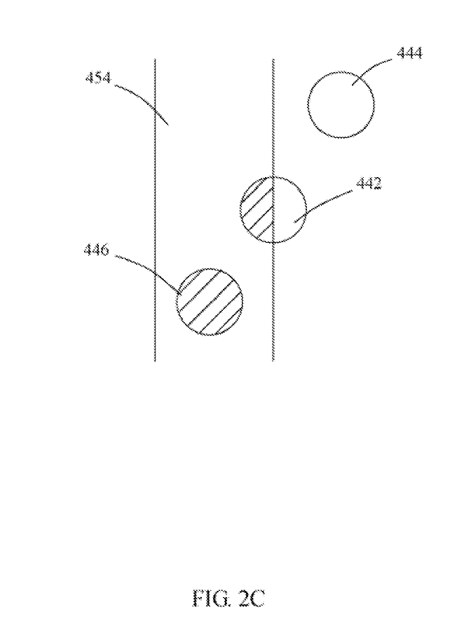

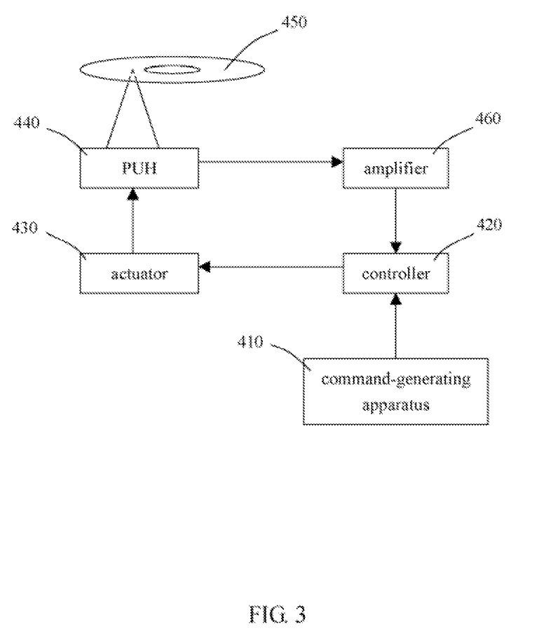

The track mapping unit 121 is used for mapping the optical disk 150 with the five imaginary tracks 151, 152, 153, 154, and 155 shown in FIG. 1, and generating and sending the mapping divisions data to the measure command setting unit 123, the storing module 126, and the judging module 128. The measure command setting unit 123 is used for setting a single get TES command for each of the five imaginary rings 151, 152, 153, 154, and 155, and transferring the get TES commands to the measure command issuing unit 125. The measure command issuing unit 125 is used for issuing the get TES commands to the controlling module 124.

When the optical disk drive 100 receives the optical disk 150, the sensor 110 detects the optical disk, then signals the track mapping unit 121 to map the optical disk 150 with the five imaginary rings 151, 152, 153, 154, and 155, and generate and send the mapping divisions data to the measure command setting unit 123, the storing module 126, and the judging module 128. Next, the measure command setting unit 123 sets a single get TES command for each of the five imaginary rings 151, 152, 153, 154, and 155 correspondingly. These get TES commands are used to measure the TESs of the five imaginary rings 151, 152, 153, 154, and 155 correspondingly. Simultaneously, the storing module 126 initializes a adjusting variable (not shown) for each of the five imaginary rings 151, 152, 153, 154, and 155.

The measure command setting unit 123 sends the get TES command to the measure command issuing unit 125 so as to measure the TES of the imaginary ring 151. The measure command issuing unit 125 issues the get TES command to the controlling module 124. The controlling module 124 generates the driving signal based on the get TES command correspondingly, and sends the driving signal to the actuator 130. The actuator 130 creates the driving force to move the PUH 140 to the imaginary track 151 based on the driving signal.

The PUH 140 projects the light beams on a track within the imaginary ring 151, and receives reflected light beams from the track. The PUH 140 measures the reflected light beams to obtain the measured TES. The amplifier 160 amplifies the measured TES, and then sends the measured TES to the storing module 126. The storing module 126 stores the measured TES into a corresponding adjusting variable. The storing module 126 detects if each of the adjusting variables stores a corresponding TES. If any adjusting variable does not store the corresponding TES, the storing module 126 signals the measure command setting unit 123 to send another get TES command to measure a TES of another imaginary ring corresponding to the adjusting variable that does not store the corresponding TES. The measure command setting unit 123 sends the get TES command to the measure command issuing unit 125. Subsequently, the optical disk drive 100 repeats the aforementioned operations until every adjusting variable stores the corresponding TES, then the measuring operation is over.

When the optical disk drive 100 reproduces data recorded on the targeted track, the command-generating apparatus 170 issues the track-jump command to the judging module 128. The judging module 128 computes the significant ring of the optical disk 150 containing the targeted track of the track-jump command, then generates and sends the seek signal to the controlling module 124. The controlling module 124 chooses the measured TES corresponding to the significant ring from the storing module 126, then generates the adjusted track-jumping control signal based on the measured TES, and the track-jump command, and sends the adjusted track-jumping control signal to the actuator 130. The actuator 130 creates the driving force to move the PUH 140 to the targeted position corresponding to the targeted track based on the adjusted track-jumping control signal.

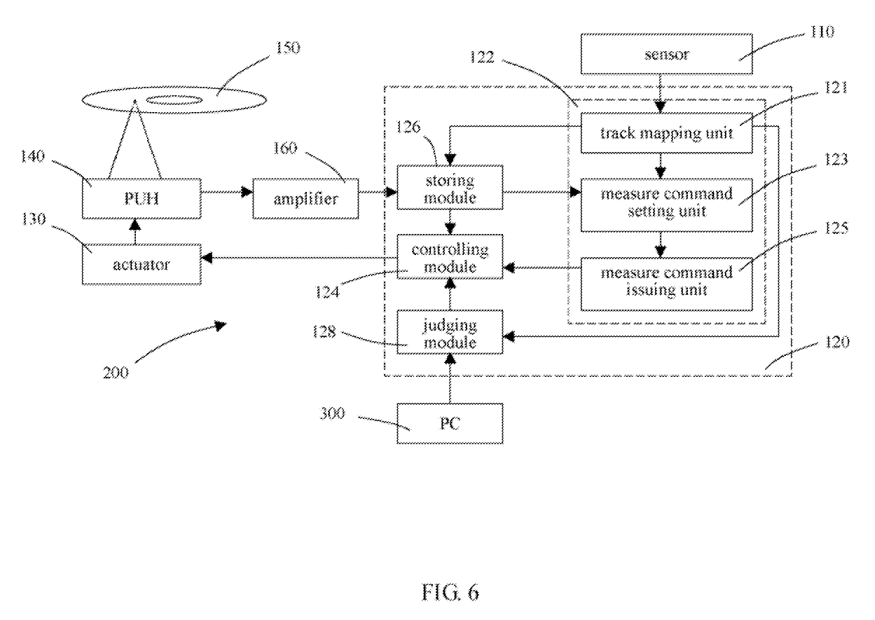

Referring to FIG. 6, the optical disk drive 200 in accordance with a second exemplary embodiment is used for receiving the track-jump command from a personal computer (PC) 300, and reproducing data from the optical disk 150. In comparison with the first embodiment, the optical disk drive 100 self-generates the track-jump command, while the optical disk drive 200 receives the track-jump command from the PC 300.

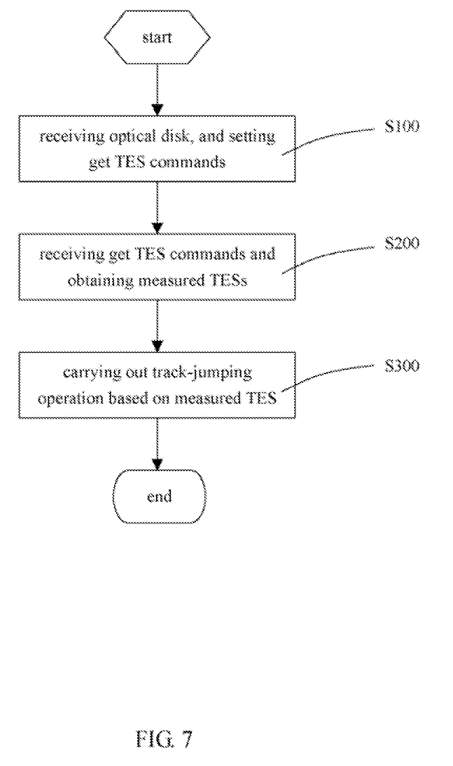

FIG. 7 is a flowchart of a preferred method for carrying out a track-jumping operation. In step S100, the optical disk drive 100 receives the optical disk 150, and setting the get TES commands for measuring TESs of the optical disk 150. In step S200, the optical disk drive 100 receives the get TES commands, and obtains the measured TESs by measuring. In step S300, the optical disk drive 100 carries out a track-jumping operation based on the measured TES.

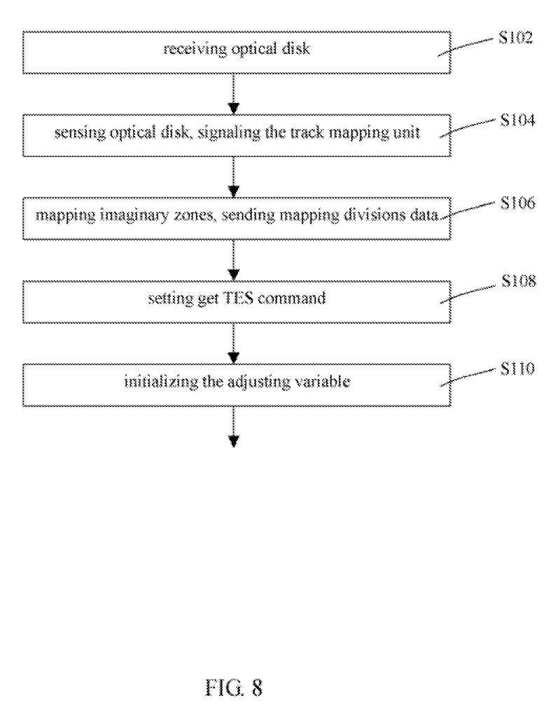

FIG. 8 is a flowchart of step S100 of FIG. 7 in detail, and including following steps.

The optical disk drive 100 receives the optical disk (step S102).

The sensor 110 senses the optical disk 150, then signals the track mapping unit 121 (step S104).

The track mapping unit 121 maps the optical disk 150 with the five imaginary rings 151, 152, 153, 154, and 155, then generates and sends the mapping divisions data to the measure command setting unit 123, the storing module 126, and the judging module 128 (step S106).

The measure command setting unit 123 sets a single get TES command for each of the five imaginary rings 151, 152, 153, 154, and 155 correspondingly, and issues a get TES command to the measure command issuing unit 125 so as to measure a TES of the imaginary ring 151 (step S108).

The storing module 126 initializes the adjusting variable (not shown) for each of the five imaginary rings 151, 152, 153, 154, and 155 (step S110).

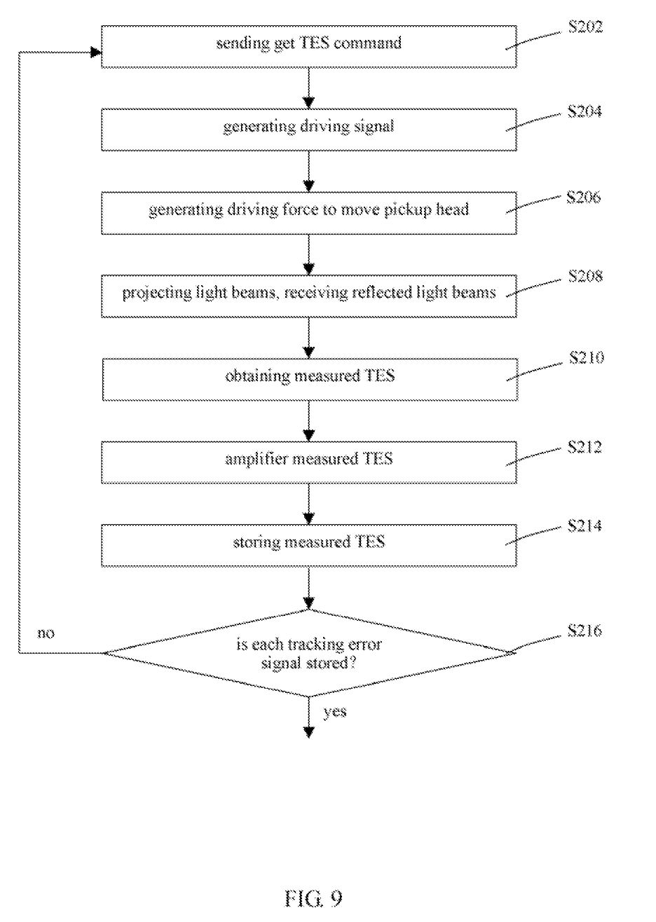

FIG. 9 is a flowchart of step S200 of FIG. 7 in detail, and including following steps.

The measure command issuing unit 125 sends the get TES command to the controlling module 124 (step S202).

The controlling module 124 generates the driving signal based on the get TES command, and sends the driving signal to the actuator 130 (step S204).

The actuator 130 generates the driving force to move the PUH 140 to the imaginary ring 151 based on the driving signal (step S206).

The PUH 140 projects light beams on a track within the imaginary ring 151, and receives reflected light beams from the track (step S208).

The PUH 140 measures the reflected light beams to obtain a measured TES (step S210).

The amplifier 160 amplifies the measured TES, and then sends the measured TES to the storing module 126 (step 212).

The storing module 126 stores the measured TES into a corresponding adjusting variable (step S214).

The storing module 126 detects if each of the adjusting variables stores a TES correspondingly. If any adjusting variable does not store the TES, the storing module 126 signals the measure command setting unit 123 to issue another get TES command to measure a TES of another imaginary ring corresponding to the adjusting variable that does not store the TES (step S216).

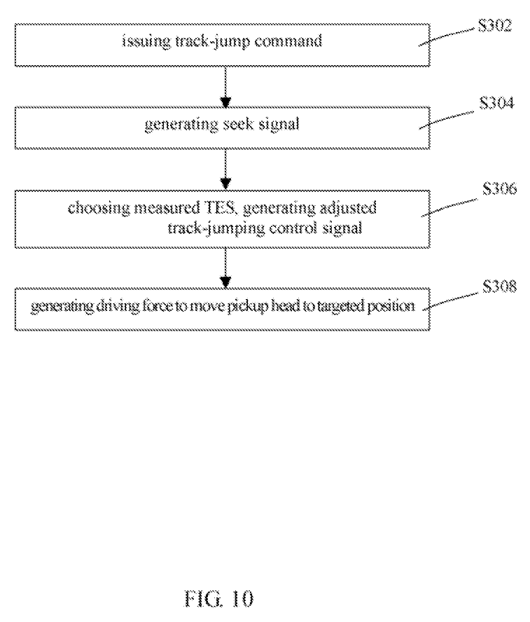

FIG. 10 is a flowchart of step S300 of FIG. 7 in detail, and including following steps.

If every adjusting variable stores the corresponding TES, the command-generating apparatus 170 issues the track-jump command to the judging module 128 (step S302).

The judging module 128 receives the track-jump command, and computes the significant ring of the optical disk 150 containing the targeted track indicated in the track-jump command, then generates and sends the seek signal to the controlling module 124 (step S304).

The controlling module 124 chooses the measured TES corresponding to the significant ring from the storing module 126, and generates the adjusted track-jumping control signal based on the measured TES and the track-jump command, and sends the adjusted track-jumping control signal to the actuator 130 (step S306).

The actuator 130 generates a driving force to move the PUH 140 to the targeted position corresponding to the targeted track based on the adjusted track-jumping control signal (step S308).

It should be emphasized that the above-described preferred embodiments, are merely possible examples of implementation of the principles of the invention, and are merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and be protected by the following claims.

What is claimed is:

1. An optical disk drive for recording data to and/or reproducing data from an optical disk, the optical disk drive comprising:
a track-jumping apparatus comprising:
a storing module being used for storing at least one measured tracking error signal; and
a controlling module being used for generating the adjusted track-jumping control signal based on a track-jump command and a measured tracking error signal chosen from the storing module;
an actuator connected to the controlling module, the actuator being used for generating a driving force based on the adjusted track-jumping control signal; and
a pickup head connected to the actuator, the pickup head being moved to a targeted position by the driving force.

2. The optical disk drive according to claim 1, further comprising a measuring module comprising a track mapping unit, a measure command setting unit, and a measure command issuing unit, wherein the track mapping unit is used for mapping the optical disk with a plurality of concentric circular imaginary rings and generating a mapping divisions data to be sent to the measure command setting unit, the measure command setting unit is used for setting a separate get TES command for each of the plurality of concentric circular imaginary rings and sending the get TES commands to the measure command issuing unit, the measure command issuing unit is used for sending the get TES commands to the controlling module.

3. The optical disk drive according to claim 2, wherein the track-jumping apparatus comprises a judging module which is connected to the controlling module and the track mapping unit, the judging module is used for receiving the track-jump command and the mapping divisions data and judging which concentric circular imaginary track of the optical disk contains the targeted track indicated in the track-jump command.

4. The optical disk drive according to claim 3, wherein the controlling module is also used for choosing the measured tracking error signal corresponding to the target concentric circular imaginary ring.

5. The optical disk drive according to claim 4, further comprising a sensor, the sensor is connected to the track mapping unit, the sensor is used for sensing the optical disk and signaling the track mapping unit that the dividing operation should be started.

6. The optical disk drive according to claim 5, wherein the optical disk drive comprises a command-generating apparatus, the command-generating apparatus is connected to the judging module, the command-generating apparatus is used for generating a track-jump command and sending the track-jump command to the judging module.

7. The optical disk drive according to claim 6, wherein the track-jump command is generated from an external command-generating apparatus, the external command-generating apparatus being connected to the optical disk drive.

8. An optical disk drive for recording data to and/or reproducing data from an optical disk based on a track-jump command, the optical disk drive comprising:
a measuring module for generating get TES commands to measure tracking error signals of the optical disk;
a storing module for storing the tracking error signals;
a controlling module for receiving a track-jump command, and choosing one of the tracking error signals from the storing module to compensate the track-jump command to generate a adjusted track-jumping control signal;
a pickup head being movable to a targeted position based on the adjusted track-jumping control signal.

9. The optical disk drive according to claim 8, further comprising an actuator coupled to the controlling module and the pickup head, and the actuator is used for receiving the adjusted track-jumping control signal and moving the pickup head to the targeted position.

10. The optical disk drive according to claim 9, wherein the optical disk is divided into a plurality of imaginary rings, the imaginary rings are concentric rings and each ring has a same radial width.

11. The optical disk drive according to claim 8, wherein the optical disk drive comprises a sensor, the sensor is connected to the measuring module, the sensor is used for sensing the optical disk and signaling the measuring module that the measuring operation should be started.

12. A track-jumping method for recording data to and/or reproducing data from an optical disk, the track-jumping method comprising the steps of:
receiving a track-jump command;
choosing a stored tracking error signal;
generating a adjusted track-jumping control signal based on the track-jump command and the tracking error signal;
moving a pickup head to a targeted position based on the adjusted track-jumping control signal.

13. The track-jumping method according to claim 12, further comprising steps of:
sensing the optical disk;
setting a get TES command;
measuring a tracking-error signal according to the get TES command;
storing the tracking-error signal.

14. The track-jumping method according to claim 13, further comprising a step of: mapping imaginary rings.

15. The track-jumping method according to claim 14, further comprising a step of: setting adjusting variables according to the imaginary rings, and each adjusting variable having a corresponding imaginary ring.

16. The track-jumping method according to claim 15, further comprising steps of:
sending out the get TES command;
generating a driving force based on the driving signal;
projecting light beams;
receiving reflected light beams.

17. The track-jumping method according to claim 16, further comprising steps of:
judging whether each adjusting variable stores a tracking error signal;
generating a measure noticing signal, and going to the “sending get TES command” step.

18. The track-jumping method according to claim 17, further comprising steps of:
judging which imaginary ring contains the targeted track;
choosing the stored tracking error signal corresponding to the significant ring.
